(19) United States
(12) Patent Application Publication
(10) Pub. No.: US 2024/0085904 A1
(43) Pub. Date: Mar. 14, 2024

(54) SYSTEM AND METHOD FOR VISUALIZING A PLURALITY OF MOBILE ROBOTS

(71) Applicant: ABB Schweiz AG, Baden (CH)

(72) Inventors: Duy Khanh Le, Hoà Thành (VN); Saad Azhar, Västerås (SE)

(21) Appl. No.: 18/261,579

(22) PCT Filed: Jan. 19, 2021
(86) PCT No.: PCT/EP2021/051035

§ 371 Date: Jul. 14, 2023

(51) Int. Cl. G05D 1/00; G06T 7/73; G06T 11/00

(52) U.S. Cl. CPC G05D 1/0044; G06T 7/73; G06T 11/00; G06T 2207/30204

(57) ABSTRACT

A method of visualizing a plurality of mobile robots includes: obtaining positions of the mobile robots; obtaining information regarding at least one non-visual characteristic of the mobile robots; rendering a scene in an augmented-reality, AR, environment; and visualizing the mobile robots as localized humanoid avatars in the scene, wherein the avatars are responsive to the non-visual characteristic.

### TECHNICAL FIELD

The present disclosure relates to the field of human-machine interaction and human-robot interaction in particular. The disclosure proposes a system and a method for indicating non-visual characteristics of a plurality of mobile robots.

### BACKGROUND

Robots are becoming prevalent in different contexts, especially in factory plants, due to the benefits they bring to production efficiency. Nowadays, it is not uncommon to find multiple robots of the same type, having almost the same external appearance and performing similar tasks in factory. At the same time, this implies certain challenges for factory workers or operators who are supposed to monitor the robots and cater for their maintenance, especially when the robots are mobile and cannot be recognized based on their location. A particular difficulty that the operators may encounter, is to identify a certain mobile robot among several mobile robots of the same type, which may be needed in order to quickly determine the age, abilities or maintenance status of the robot.

As FIG. 1 suggests, the presence of multiple robots 110.1, 110.2, 100.3 which have similar external appearances confuses or stresses the operators. It also compels them to repeatedly differentiate the robots and retrieve or memorize their different individual information. Besides, conventional representations that use cluttering texts or charts can distract the operators' perception, requiring an extensive effort for them to absorb and remember the information.

### SUMMARY

One objective of the present disclosure is to make available a system and method that allow an operator to easily recognize individual information of a mobile robot. It is a particular objective to facilitate the recognition of a mobile robot's individual information in a situation where the mobile robot operates together with other mobile robots which resemble each other externally.

These and other objectives are achieved by the invention defined by the independent claims. The dependent claims relate to advantageous embodiments of the invention.

In a first aspect of the invention, there is provided a method of visualizing a plurality of mobile robots. The method comprises: obtaining positions of the mobile robots; obtaining information regarding at least one non-visual characteristic of the mobile robots; rendering a scene in an augmented-reality (AR) environment; and visualizing the mobile robots as localized humanoid avatars in the scene, wherein the avatars are responsive to the non-visual characteristic.

It is understood that a “non-visual characteristic” in the sense of the claims is a characteristic or property that cannot be determined by seeing the robot on its own (e.g., size, type, load, health status) or seeing the robot in its environment (e.g., location, speed). The non-visual characteristic may in particular be a functional ability of the robot. It is furthermore understood that the term “AR” shall cover AR in the strict sense, extended reality (XR) and/or virtual reality (VR).

The method according to the first aspect of the invention makes the non-visual characteristic perceivable by the operator viewing the AR environment. The non-visual characteristic is relevant to an operator who is contemplating to issue a work order to one of the mobile robots or to perform maintenance on it. Without the AR visualization, the operator would be unaware of what services and performance he could expect from each robot and unaware of its need for maintenance; in such circumstances, the operator may waste time and other resources by choosing the wrong robot. This advantage is achievable particularly if at least two of the visualized mobile robots share a common external appearance; their difference with respect to the non-visual characteristic will influence their avatars in the AR scene and make them distinguishable. The operator can view the visualization in an unobtrusive way, e.g., by wearing AR glasses. Furthermore, since human operators have an innate ability to accurately distinguish among human faces and facial expressions, the visualization is very intuitive and may be considered to maximize the amount of information conveyed by an AR scene of a given size.

In another aspect of the invention, there is provided an information system configured to visualize a plurality of mobile robots. The information system comprises: a communication interface for obtaining positions of mobile robots and information regarding at least one non-visual characteristic of the mobile robots; an AR interface; and processing circuitry configured to render a scene using the AR interface, in which the mobile robots are visualized as localized humanoid avatars, wherein the avatars are responsive to the non-visual characteristic.

The information system according to the second aspect is technically advantageous in a same or similar way as the method discussed initially.

A further aspect relates to a computer program containing instructions for causing a computer, or the information system in particular, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storages of magnetic, optical or solid-state type. Still within the scope of “data carrier”, such memories may be fixedly mounted or portable.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 shows a workspace shared between an operator and a plurality of mobile robots;

FIG. 2 shows a scene in an AR environment including humanoid avatars representing the mobile robots;

FIG. 3 is a flowchart of a method of visualizing a plurality of mobile robots, according to embodiments of the invention;

FIG. 4 shows an information system including a wearable AR interface configured to visualize a plurality of mobile robots, according to embodiments of the invention; and

FIG. 5 illustrates humanoid avatars which are visually different in response to differences in a non-visual characteristic of the mobile robots.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

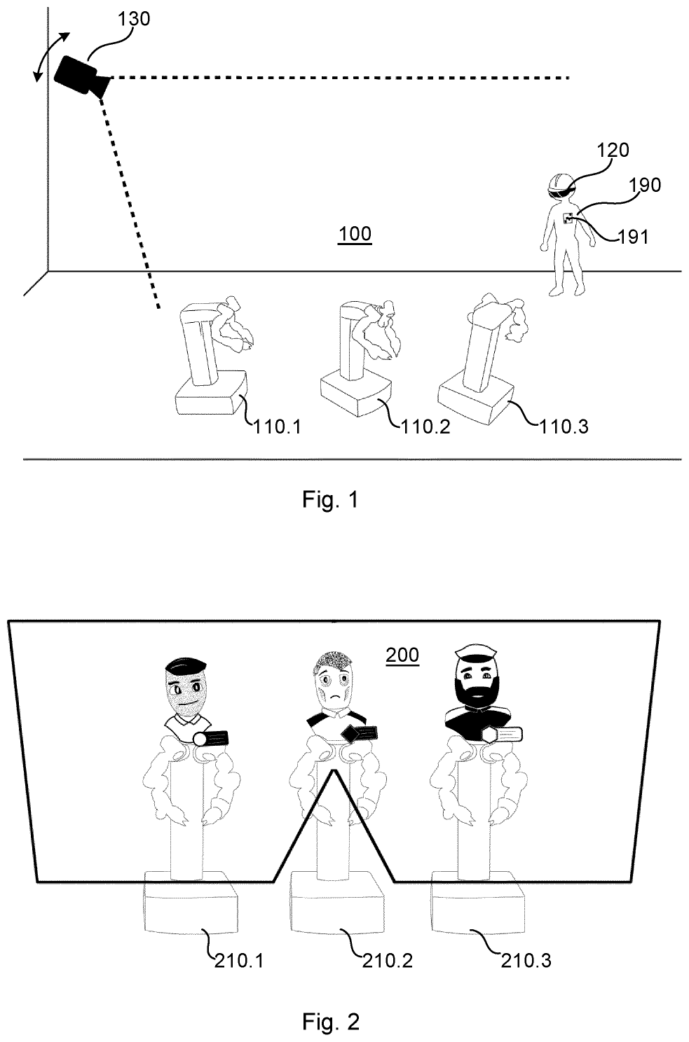

FIG. 1 shows a workspace 100 shared between an operator 190 and three mobile robots 110.1, 110.2, 110.3. To a naked eye, each mobile robot 110.1, 110.2, 110.3 has a similar external appearance and are distinguishable only by their momentary poses or positions, or by printed marks or labels that cannot easily be recognized from a distance. To study such labels, the operator 190 is normally required to halt the mobile robots 110.1, 110.2, 110.3 and approach them.

FIG. 2 shows the same scene viewed by the operator 190 through an AR interface 120. In the AR environment, each robot 110 is visualized as a humanoid (person-like) avatar 210.

The avatars 210 are localized in the AR scene 200. Relative positions of two avatars 210 may correspond to the relative positions of the mobile robots 110 they represent; this may be achieved by applying a perspective projection to the positions of the mobile robots 110. The position information of the mobile robots 110 may have been obtained from an external camera 130 (see FIG. 1). The external camera 130 is preferably stationary, i.e., carried by neither a robot 110 nor the operator 190. The positioning of the operator 190 may be facilitated by attaching an optical, radio-frequency or other marker 191 to the operator 190 or the AR interface 120 if it is carried or worn by the operator 190.

The three avatars 210 are not copies of each other but differ meaningfully in dependence of the non-visual characteristics of the robots 110 that they represent. In other words, an avatar 210 is “responsive to” a non-visual characteristic if a feature of the avatar 210 will be different for different values of the non-visual characteristic. The avatars 210 may differ from each other with respect to at least the following variable features: face color, skin texture, facial expression, garments (style, color, pattern, wear/tear), badge/tag, hairstyle, beard, spectacles, speech balloons, thought bubbles.

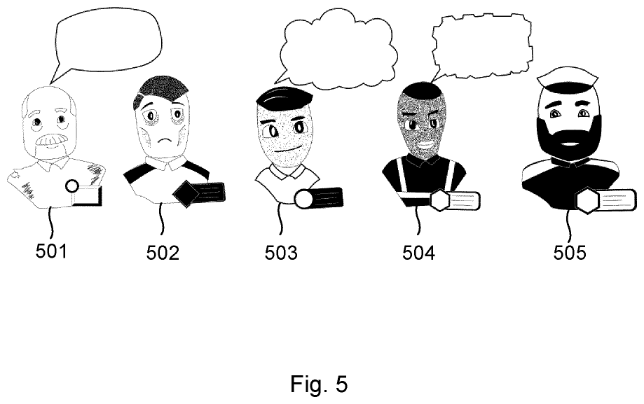

To illustrate the multitude of recognizable avatars that can be generated by combining such features, FIG. 5 shows five humanoid avatars 501, 502, 503, 504, 505 in addition to those in FIG. 2. Here, avatars 501 and 505 are bearded but neither of avatars 502, 503 and 504 is. Avatar 501 will be recognized as relatively older than the others. Avatars 501 and 503 wear circular badges on their chests; avatar 502 wears a diamond-shaped badge; avatars 504 and 505 wear hexagonal badges. Avatar 505 is the only one to wear a hat. Avatars 501, 503 and 504 have speech balloons of different shapes above their heads. The clothing differs among the five avatars 501, 502, 503, 504, 505 as regards model, pattern and brightness. Still further visible differences can be recognized easily among the examples given in FIG. 5, and those skilled in the art will be able to propose still further avatars if this is needed for a given use case.

Visual differences among the avatars 210 reflect differences with respect to the non-visual features, such as different tasks of the visualized mobile robots 110. This information is relevant to the operator 190, who can thereby assess the impact of halting a robot 110 for maintenance purposes or of assigning a new task to it.

As another example, the avatars 210 may differ when they represent mobile robots 110 with different times in service. The time in service may be counted from the time of deployment or since the latest maintenance. The time in service is one indicator of a robot's 110 need for planned maintenance. If the robot 110 has been well maintained and recently serviced. The face of its avatar 210 may look bright and energetic, and the clothing new.

FIG. 4 shows an information system 400 which includes an AR interface 120 that can be associated with (e.g., worn, carried by) the operator 190. The operator 190 may work in an environment 100 where one or more mobile robots 110 operate. The robots 110 may be mobile over a surface by means of wheels, bands, claws, movable suction cups or other means of propulsion and/or attachment. The surface may be horizontal, slanted or vertical; it may optionally be provided with rails or other movement guides.

The AR interface 120 is here illustrated by glasses—also referred to as smart glasses, AR glasses or a head-mounted display (HMD)—which when worn by the operator 190 user allows him to observe the environment 100 through the glasses in the natural manner. The AR interface 120 is further equipped with arrangements for generating visual stimuli adapted to produce, from the operator's 190 point of view, an appearance of graphic elements overlaid (or superimposed) on top of the view of the environment 100. Various ways to generate such stimuli in see-through HMDs are known per se in the art, including diffractive, holographic, reflective and other optical techniques for presenting a digital image to the operator 190.

The information system 400 further comprises a communication interface towards the optional external camera 130 and a robot information source 490, symbolically illustrated in FIG. 4 as an antenna 410, and processing circuitry 430. The communication interface 410 allows the information system 400 to obtain up-to-date values of the non-visual characteristics of the mobile robots 210 as well as their positions and the position of the operator 190. The robot information source 490 may be—or be connected to—a host computer in charge of scheduling or controlling the mobile robots' 210 movements and tasks in the work environment 100 and/or monitoring and coordinating the robots 210. To obtain the user's position, the system 400 may either rely on positioning equipment in the AR interface 120 (e.g., a cellular chipset with positioning functionality, a receiver for a satellite navigation system), make a request to an external positioning service, or use data collected by the external camera 130.

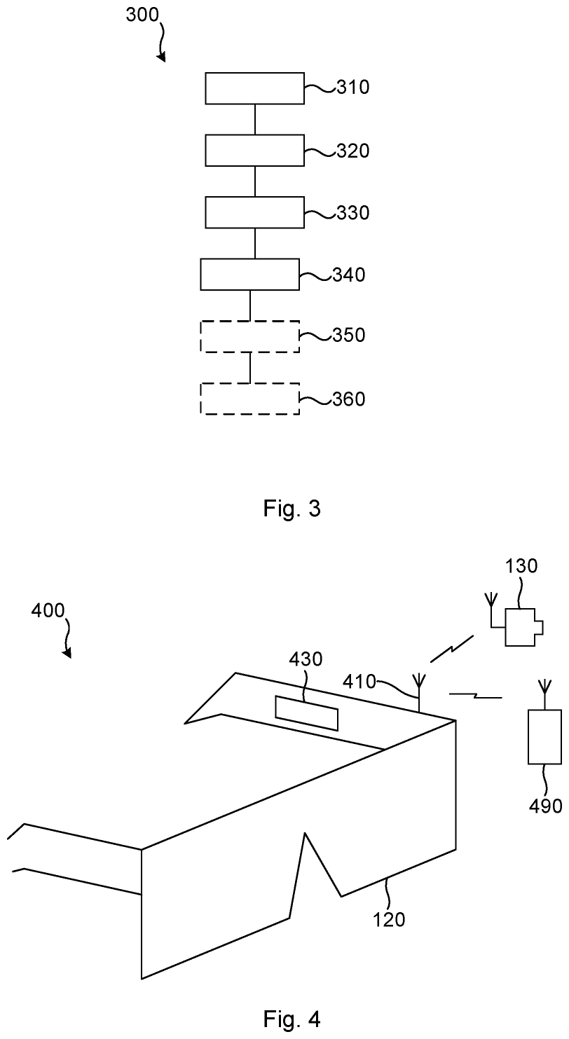

FIG. 3 is a flowchart of a method 300 of visualizing a plurality of mobile robots 110. It may correspond to a programmed behavior of the information system 400.

In a first step 310, positions of the mobile robots 110 are obtained. The robot information source 490 may provide this information, as may the camera 130.

In a second step 320, information regarding at least one non-visual characteristic of the mobile robots is obtained. The robot information source 490 may provide this information as well. As mentioned above, example non-visual characteristics of the mobile robots 110 include size, type, load, health status, maintenance status, location, destination, speed, a functional ability, a currently assigned task. In some embodiments, the non-visual characteristics do not include the identity of a mobile robot 110.

In a third step 330, a scene 200 in an AR environment is rendered.

In a fourth step 340, the mobile robots are visualized as localized humanoid avatars 210 in the scene 200. The avatars 210 are responsive to the non-visual characteristics, i.e., a feature of the avatar 210 is different for different values of the non-visual characteristic.

In an optional fifth step 350, an operator position is obtained. This may proceed by means of positioning equipment in the AR interface 120, an external positioning service or an external camera 130.

In a further optional sixth step 360, the AR scene 200 is adapted on the basis of the operator position. The adaptation may consist in a reassignment of the imaginary camera position or camera orientation of a perspective projection by which the scene 200 is rendered.

Steps 350 and 360 are particularly relevant when the mobile robots 110 share a workspace 100 with the operator 190.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A method of visualizing a plurality of mobile robots, the method comprising:
obtaining positions of the mobile robots;
obtaining information regarding at least one non-visual characteristic of the mobile robots;
rendering a scene in an augmented-reality, AR, environment; and
visualizing the mobile robots as localized humanoid avatars in the scene, wherein the avatars are responsive to the non-visual characteristic.

2. The method of claim 1, wherein the non-visual characteristic represents a functional ability of a mobile robot

3. The method of claim 1, wherein at least two of the visualized mobile robots, which differ with respect to the non-visual characteristic, share a common external appearance.

4. The method of claim 1, wherein the avatars are responsive to a task of each visualized mobile robot.

5. The method of claim 1, wherein the avatars are responsive to a time in service of each visualized mobile robot.

6. The method of claim 1, wherein relative positions of the avatars correspond to relative positions of the mobile robots.

7. The method of claim 1, wherein the position information of the mobile robots is obtained from an external camera.

8. The method of any of claim 1, wherein the mobile robots share a workspace with at least one operator, further comprising:
obtaining an operator position; and
adapting the AR environment on the basis of the operator position.

9. The method of claim 8, wherein the operator position is obtained from an external camera, which is configured to detect an optical or other marker attached to the operator or an operator-carried AR interface.

10. An information system configured to visualize a plurality of mobile robots, the information system comprising:
a communication interface for obtaining
positions of mobile robots, and
information regarding at least one non-visual characteristic of the mobile robots;
an augmented reality, AR, interface; and
processing circuitry configured to render a scene using the AR interface, in which the mobile robots are visualized as localized humanoid avatars, wherein the avatars are responsive to the non-visual characteristic.

11. A computer program comprising instructions to cause an information system to execute steps of a method of visualizing a plurality of mobile robots, the method including:
obtaining positions of the mobile robots;
obtaining information regarding at least one non-visual characteristic of the mobile robots;
rendering a scene in an augmented reality, AR environment; and
visualizing the mobile robots as localized humanoid avatars in the scene, wherein the avatars are responsive to the non-visual characteristic.

12. A data carrier having stored thereon a computer program comprising instructions to cause an information system to execute steps of a method of visualizing a plurality of mobile robots, the method including:
obtaining positions of the mobile robots;
obtaining information regarding at least one non-visual characteristic of the mobile robots;
rendering a scene in an augmented reality, AR environment; and
visualizing the mobile robots as localized humanoid avatars in the scene, wherein the avatars are responsive to the non-visual characteristic.

13. The method of claim 2, wherein at least two of the visualized mobile robots, which differ with respect to the non-visual characteristic, share a common external appearance.

14. The method of claim 2, wherein the avatars are responsive to a task of each visualized mobile robot.

15. The method of claim 2, wherein the avatars are responsive to a time in service of each visualized mobile robot.

16. The method of claim 2, wherein relative positions of the avatars correspond to relative positions of the mobile robots.

17. The method of any of claim 2, wherein the position information of the mobile robots is obtained from an external camera.

18. The method of any of claim 2, wherein the mobile robots share a workspace with at least one operator, further comprising:
obtaining an operator position; and
adapting the AR environment on the basis of the operator position.
